(19) United States
(12) Patent Application Publication
(10) Pub. No.: US 2025/0053158 A1
(43) Pub. Date: Feb. 13, 2025

(54) NUMERICAL CONTROL DEVICE, AND COMPUTER-READABLE STORAGE MEDIUM

(71) Applicant: Fanuc Corporation, Minamitsuru-gun, Yamanashi (JP)

(72) Inventor: Takuma OOKURA, Minamitsuru-gun, Yamanashi (JP)

(73) Assignee: Fanuc Corporation, Minamitsuru-gun, Yaman (JP)

(21) Appl. No.: 18/721,742

(22) PCT Filed: Dec. 28, 2021
(86) PCT No.: PCT/JP2021/048990

§ 371 Date: Jun. 19, 2024

(51) Int. Cl. G05B 19/416; G05B 19/4093

(52) U.S. Cl. CPC G05B 19/4166; G05B 19/40937; G05B 2219/37506; G05B 2219/45161

(57) ABSTRACT

This numerical control device includes a calculation unit that calculates, from a machining program, a start point and an end point of a reciprocating movement of a feed shaft; a control unit that synchronous controls, between the start point and the end point calculated by the calculation unit, a feed movement of the feed shaft and a relative rotational movement between a tool and a workpiece; and a determination unit that determines whether a condition for reversing the feed direction of the feed shaft has been satisfied before the feed shaft reaches the start point or the end point during synchronous control. When the determination unit determines that the condition for reversing the feed direction of the feed shaft has been satisfied, the control unit reveres the feed direction of the feed shaft before the feed shaft reaches the start point, or the end point.

### CROSS REFERENCE TO RELATED APPLICATIONS

This is the U.S. National Phase application of PCT/JP2021/048990, filed Dec. 28, 2021, the disclosures of this applications being incorporated herein by reference in their entireties for all purposes.

### FIELD OF THE INVENTION

The present disclosure relates to a numerical control device and a computer-readable storage medium.

### BACKGROUND OF THE INVENTION

It is known that when honing is carried out on the inner surface of a hole, grinding marks, where helical grooves intersect one another, are formed on the machined surface. The grinding marks act as lubrication grooves for holding lubrication oil when a sliding material slides inside the hole. For example, the grinding marks act as the lubrication grooves when a piston slides inside a cylinder. Patent Literature 1 discloses that synchronous control is performed to control a feedrate and a rotation speed of a tool so as to keep an intersecting angle constant between the grinding marks.

### PATENT LITERATURE

[Patent Literature 1] Japanese Patent Laid-Open Publication No. 2011-224753

### SUMMARY OF THE INVENTION

However, when the synchronous control is carried out on the feedrate and the rotation speed of the tool, the tool rotation temporarily stops when the feed direction of the tool is reversed. Then, when the tool rotation is started from the state where the tool rotation is stopped, large frictional force is generated between the tool and a workpiece, which may cause deterioration of quality of a machined face.

It is therefore desirable to improve the quality of the machined face in the honing of the inner surface of the hole.

A numerical control device includes a calculator for calculating a start point and an end point of reciprocation of a feed axis by using a machining program, a controller for conducting, between the start point and the end point calculated by the calculator, synchronous control on feed movement of the feed axis and relative rotational movement between a tool and a workpiece, and a determinator for determining whether or not a condition for reversing a feed direction of the feed axis is satisfied during the synchronous control before the feed axis reaches the start point or the end point, wherein when the determinator determines that the condition is satisfied, the controller reverses the feed direction of the feed axis before the feed axis reaches the start point or the end point.

A computer-readable storage medium that stores commands to allow a computer to conduct calculation of a start point and an end point of reciprocation of a feed axis by using a machining program, synchronous control between the start point and the end point thus calculated to control feed movement of the feed axis and relative rotational movement between a tool and a workpiece, determination as to whether or not a condition for reversing a feed direction of the feed axis is satisfied during the synchronous control before the feed axis reaches the start point or the end point, and when it is determined that the condition is satisfied, reverse of the feed direction of the feed axis before the feed axis reaches the start point or the end point.

One aspect of the present disclosure can improve the quality of the machined face in the honing of the inner surface of the hole.

### BRIEF DESCRIPTION OF THE DRAWINGS

FIG. 1 is a block diagram showing an example of a hardware configuration of a machine tool;

FIG. 2 shows an outline of honing;

FIG. 3 illustrates a crosshatch;

FIG. 4 shows an example of functions of a numerical control device;

FIG. 5 shows an example of honing program;

FIG. 6A shows an example of pulse signals output to a servo amplifier;

FIG. 6B shows an example of pulse signals output to a spindle amplifier;

FIG. 7A shows an example of pulse signals output to a servo amplifier in a conventional art;

FIG. 7B shows an example of pulse signals output to a spindle amplifier in the conventional art;

FIG. 8 shows an example of operations of a tool;

FIG. 9 shows a change in a tool position during honing; and

FIG. 10 is a flowchart showing an example of processing conducted in the numerical control device.

A description will now be made about a numerical control device according to an embodiment of the present disclosure by referring to the accompanying drawings. It is to be noted that all combinations of features described in the following embodiments are not necessarily required to solve the above-described problems. In addition, detailed descriptions that are superfluous may be omitted. The description of the following embodiments and the drawings are provided to help those skilled in the art to fully understand the present disclosure and are not intended to limit the scope of claims.

The numerical control device is for controlling industrial machines, by way of example. The industrial machines include machine tools and industrial robots. The machine tools are, for instance, a lathe, a machining center, a drilling center and a combined machine tool. The following description will be about a numerical control device for controlling machine tools as an example.

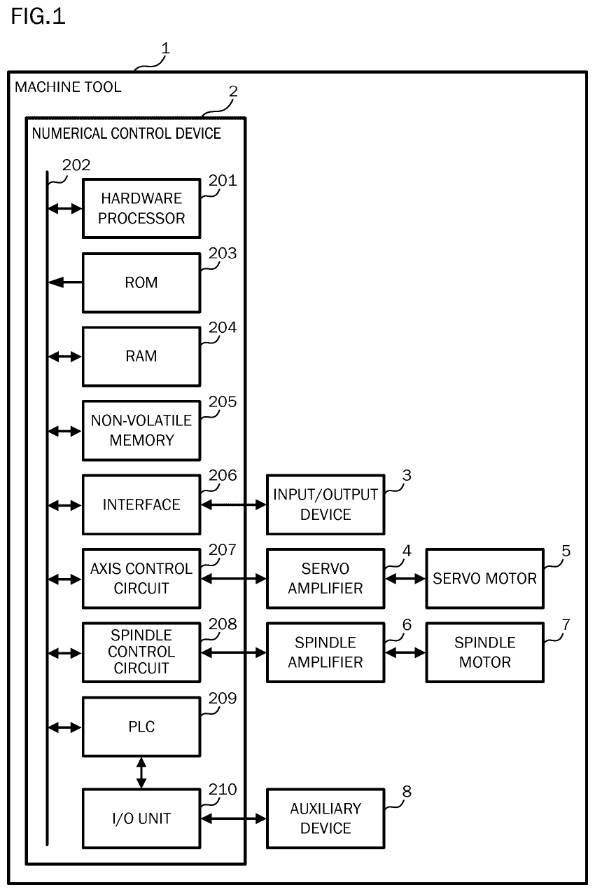

FIG. 1 is a block diagram showing an example of a hardware configuration of a machine tool having a numerical control device.

A machine tool 1 includes a numerical control device 2, an input/output device 3, a servo amplifier 4, a servo motor 5, a spindle amplifier 6, a spindle motor 7 and an auxiliary device 8.

The numerical control device 2 is configured to control the entire machine tool 1. The numerical control device 2 includes a hardware processor 201, a bus 202, a ROM (Read Only Memory) 203, a RAM (Random Access Memory) 204 and a non-volatile memory 205.

The hardware processor 201 is configured to control the entire numerical control device 2 according to a system program. The hardware processor 201 is configured to read a system program stored in the ROM 203 via the bus 202 to conduct various processes based on the system program. The hardware processor 201 controls the servo motor 5 and the spindle motor 7 based on a machining program. The hardware processor 201 is, for example, a CPU (Central Processing Unit) or an electronic circuit.

The hardware processor 201 conducts an analysis on the machining program and outputs control commands to the servo motor 5 and the spindle motor 7 at each control cycle, by way of example.

The bus 202 is a communication channel configured to interconnect pieces of hardware in the numerical control device 2. The pieces of hardware in the numerical control device 2 exchange pieces of data through the bus 202.

The ROM 203 is a storage unit configured to store, for example, a system program for controlling the entire numerical control device 2. The ROM 203 is a computer-readable storage medium.

The RAM 204 is a storage unit configured to temporarily store various data. The RAM 204 acts as a work area for the hardware processor 201 to process various data.

The non-volatile memory 205 is a storage unit configured to retain data even when the machine tool 1 is turned off and thus there is no power supply to the numerical control device 2. The non-volatile memory 205 stores the machining program and various parameters, by way of example. The non-volatile memory 205 is a computer-readable storage medium. The non-volatile memory 205 is configured with a memory that is backed up by a battery or an SSD (Solid-State Drive).

The numerical control device 2 further includes an interface 206, an axis control circuit 207, a spindle control circuit 208, a programmable logic controller (PLC) 209 and an I/O unit 210.

The interface 206 is configured to connect the bus 202 to the input/output device 3. The interface 206 transmits, for example, various data processed by the hardware processor 201 to the input/output device 3.

The input/output device 3 is configured to receive the various data via the interface 206 and display the various data. In addition to that, the input/output device 3 is configured to accept various data input and in turn transmit the various data via the interface 206 to, for instance, the hardware processor 201.

The input/output device 3 is a touch panel, by way of example. In the case where the input/output device 3 is the touch panel, the input/output device 3 is, for instance, a capacitive touch panel. The touch panel is not limited to the capacitive type, and may be a touch panel of another type. The input/output device 3 is installed on an operation board, not shown, in which the numerical control device 2 is housed.

The axis control circuit 207 is for controlling the servo motor 5. The axis control circuit 207 is configured to receive control commands from the hardware processor 201 and output commands for driving the servo motor 5 to the servo amplifier 4. For example, the axis control circuit 207 transmits a torque command for controlling torque of the servo motor 5 to the servo amplifier 4.

In response to the commands from the axis control circuit 207, the servo amplifier 4 supplies a current to the servo moto 5.

The servo moto 5 is driven by the current supplied from the servo amplifier 4. For example, the servo motor 5 is coupled to a ball screw which drives a tool post. When the servo motor 5 is driven, a structure of the machine tool 1, such as the tool post, is moved in a direction of a feed axis. The servo motor 5 incorporates an encoder (not shown) for detecting a position of the feed axis and a feedrate. Position feedback information and feedrate feedback information respectively indicating the position of the feed axis and the feedrate of the feed axis detected by the encoder are fed back to the axis control circuit 207. On the basis of the obtained information, the axis control circuit 207 conducts feedback control on the feed axis.

The spindle control circuit 208 is for controlling the spindle motor 7. The spindle control circuit 208 is configured to transmit commands for driving the spindle motor 7 to the spindle amplifier 6 in response to control commands from the hardware processor 201. For example, the spindle control circuit 208 transmits a spindle speed command for controlling a rotation speed of the spindle motor 7 to the spindle amplifier 6.

The spindle amplifier 6 supplies a current to the spindle motor 7 in response to the command received from the spindle control circuit 208.

The spindle motor 7 is driven by the current supplied from the spindle amplifier 6. The spindle motor 7 is coupled to a spindle to rotate the spindle.

The PLC 209 is for executing a ladder program to control the auxiliary device 8. The PLC 209 is configured to transmit commands via the I/O unit 210 to the auxiliary device 8.

The I/O unit 210 is an interface for connecting the PLC 209 to the auxiliary device 8. The I/O unit 210 transfers the commands received from the PLC 209 to the auxiliary device 8.

The auxiliary device 8 is installed in the machine tool 1 to perform auxiliary operations in the machine tool 1. The auxiliary device 8 operates on the basis of the commands received from the I/O unit 210. The auxiliary device 8 may be a device that is arranged in the vicinity of the machine tool 1. For example, the auxiliary device 8 is a turret, a coolant injection apparatus or an open/close door drive unit.

Next, a description will be made about machining carried out in the machine tool 1. The machine tool 1 conducts honing. The honing is a process in which a workpiece and a tool are relatively reciprocated and rotated while the tool is pressed against the inner surface of a hole. The hole to be machined is a cylinder, for instance. The tool to be used for honing is a grinder.

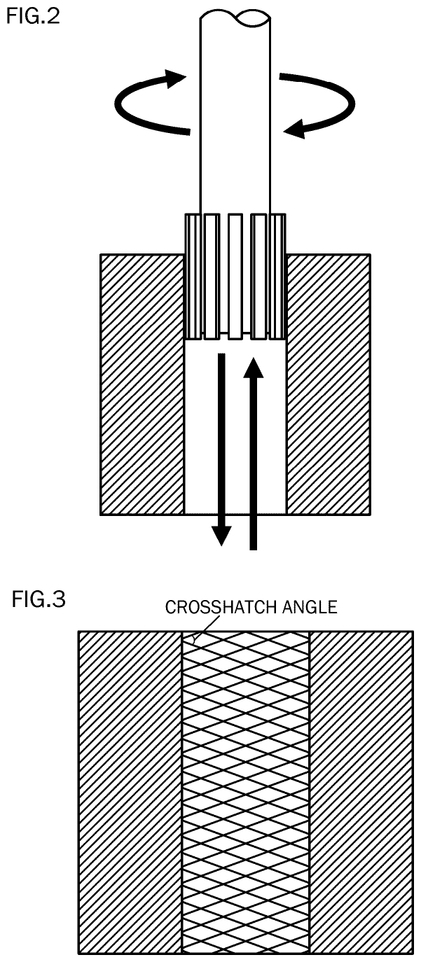

FIG. 2 illustrates an outline of the honing. The honing is carried out in such a way that the grinder attached to the spindle rotates and reciprocates inside the hole. The grinder has a diameter expansion function to machine the inner surface of the hole while pressurizing the inner surface of the hole.

The workpiece and the tool rotate and reciprocate relative to each other. For example, the tool may rotate and reciprocate while the workpiece is fixed. Alternatively, the workpiece may rotate and reciprocate while the tool is fixed, or either the tool or the workpiece may rotate while the other reciprocates. The case where the machining is carried out while the tool rotates and reciprocates will be described below.

In the honing, mesh-like grinding marks are formed on the inner surface of the hole. The mesh-like grinding marks are formed in such a way that a plurality of grinding marks formed in spirals and parallel to one another intersect at a predefined angle. For example, the grinding marks serve as lubrication grooves for holding lubrication oil when a piston operates inside the hole. The grinding marks formed by the honing will be hereinafter referred to as crosshatches.

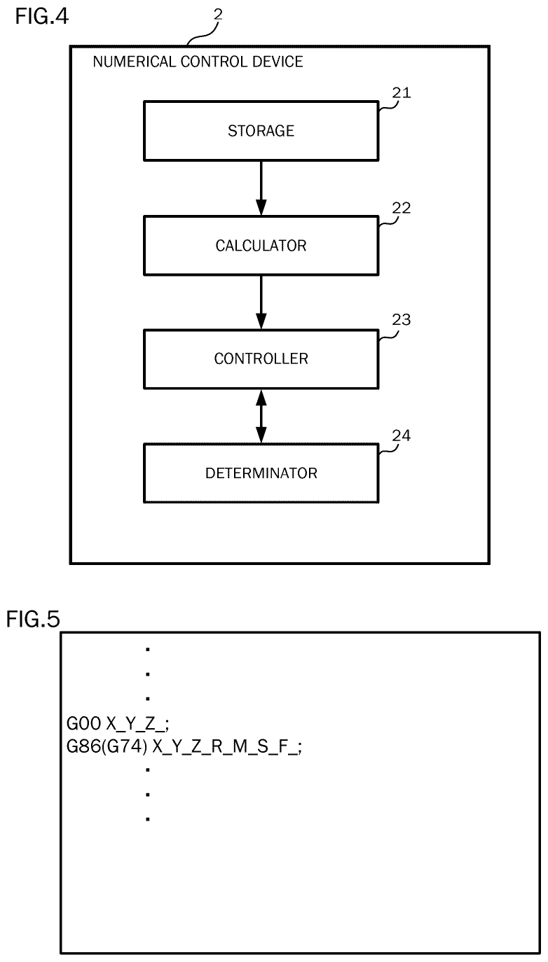

FIG. 3 is a diagram illustrating the crosshatches formed on the inner surface of the hole. It is preferable that the crosshatches are formed at a constant angle throughout the hole. Thus, in the honing, synchronous control is conducted to control the feedrate and the rotation speed of the tool. When the synchronous control is conducted, the crosshatches are formed at the constant angle. As a consequence, the multiple crosshatches intersect one another at the constant angle.

Next, functions of the numerical control device 2 will be described.

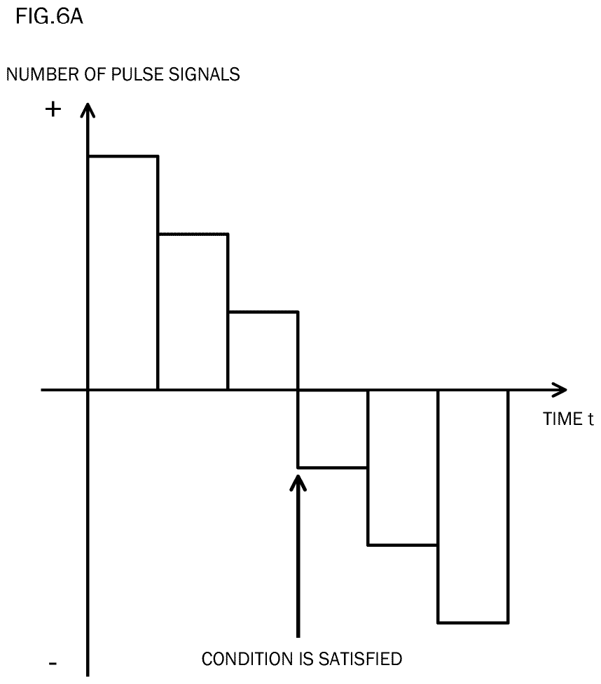

FIG. 4 shows an example of the functions of the numerical control device 2. The numerical control device 2 includes a storage 21, a calculator 22, a controller 23 and a determinator 24. The storage 21 is actualized in such a way that, for example, various data are stored in the RAM 204 or the non-volatile memory 205. The calculator 22, the controller 23 and the determinator 24 are actualized in such a way that, for example, the hardware processor 201 conducts arithmetic processing by using system programs stored in the ROM 203 and machining programs and various data stored in the non-volatile memory 205.

The storage 21 is configured to store the machining programs. The machining program includes a honing program, by way of example.

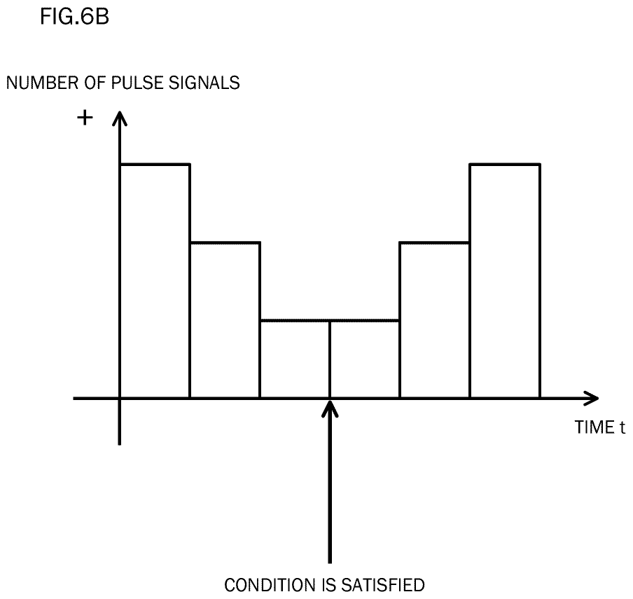

FIG. 5 shows an example of the honing program. The honing program designates a positioning command “G00X_Y_Z;” for positioning the tool at a positioning point. In this command, the underscore “_” means that a predetermined numerical value is inserted therein. Numerical values following letters “X”, “Y” and “Z” are for specifying the position of X, Y and Z coordinates, respectively, in a predetermined coordinate system.

Command “G_X_Y_Z_R_M_S_F;” written on the next line in the positioning command is a honing cycle command for executing the honing.

The code “G_” is a G-code that indicates a honing cycle. The G-code can be designated with the alphabet “G” and a predefined two-digit number.

The codes “X_Y_” designate the positions of the X coordinate and the Y coordinate in the predetermined coordinate system at which a hole is formed. The code “M_” is a M-code that designates a type of the honing.

The code “S_” is a S-code that specifies a rotation speed of a spindle. The code “R_” defines a distance from the positioning point of the tool to a start point of reciprocation of the tool. The start point is also called R-point. The position of the start point is, for instance, about ⅓ of the length of the grinder from the mouth of the hole to the interior of the hole. If the tool is positioned at the start point, about ⅓ of the tip of the grinder is inserted into the hole.

The code “Z_” specifies a distance from the start point to an end point in the reciprocation of the tool. The end point is also called Z-point. The position of the end point is, for instance, outside the hole by about ⅔ of the length of the grinder from the exit of the hole. If the tool is positioned at the end point, about ⅓ of the base end of the grinder is inserted into the hole. The code “Z_” may specify the position of the end point in a predetermined coordinate system. The code “F_” is a F-code that specifies a cutting feedrate.

The honing program is not limited to the type shown in FIG. 5. For example, the code “Q_” may be used to specify a crosshatch angle. In here, the crosshatch angle is, for example, an angle at which multiple crosshatches intersect one another. Moreover, code “,D_” may be used to specify a machining diameter of the hole.

The calculator 22 is configured to calculate a start point and an end point of a reciprocation of a feed axis according to the machining program. For example, the calculator 22 calculates a position of the start point based on a positioning point designated by the positioning command and the code “R_” designated in the honing cycle command. In addition to that, the calculator 22 calculates the position of the end point based on the calculated position of the start point and the code “Z_” designated in the honing cycle command. The start point and the end point are represented by coordinate values in a workpiece coordinate system, by way of example.

The controller 23 is configured to conduct synchronous control between the start point and the end point calculated by the calculator 22 to control feed movement of the feed axis and relative rotational movement between the tool and a workpiece. In the synchronous control, the controller 23 synchronizes the relative rotational movement between the tool and the workpiece with respect to the feed movement of the feed axis, for instance. In this case, it can be understood that the synchronous control is for making the rotational movement of a rotary axis to follow the feedrate of the feed axis. Alternatively, it can be understood that the synchronous control is for making the position of the rotary axis to follow the position of the feed axis.

The determinator 24 is configured to determine whether or not a condition for reversing a feed direction of the feed axis is satisfied during the synchronous control before the feed axis reaches the start point or the end point. The condition for reversing the feed direction is for changing the feed direction into the opposite direction. If the feed direction is toward the end point, the determinator 24 determines whether or not the condition for reversing the feed direction is satisfied before the tool reaches the end point. In this case, the reversed direction is the direction toward the start point.

If the feed direction is toward the start point, the determinator 24 determines whether or not the condition for reversing the feed direction is satisfied before the tool reaches the start point. In this case, the reversed direction is the direction toward the end point.

The condition is, for example, that the rotation speed in the rotational movement reaches a predefined rotation speed or lower. Under the synchronous control, the feedrate of the feed axis is decelerated near the start point or the end point, and the rotation speed of the rotary axis is also decelerated. The condition for reversing the feed direction of the feed axis is that the decelerated rotation speed becomes equal to or lower than the predetermined rotation speed.

When the determinator 24 determines that the condition is satisfied, the controller 23 reverses the feed direction of the feed axis before the feed axis reaches the start point or the end point. More specifically, the controller 23 outputs a command for reversing the feed direction of the feed axis to the servo amplifier 4 to thereby reverse the feed direction. The command for reversing the direction is pulse signals.

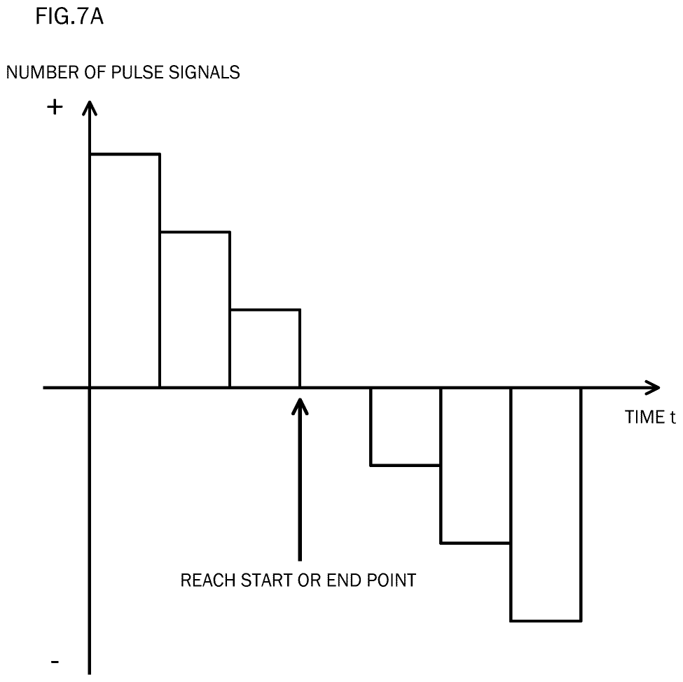

FIG. 6A shows an example of pulse signals to be output to the servo amplifier. The vertical axis indicates the number of pulse signals in one control cycle, and the horizontal axis indicates time. The plus side indicates the number of pulse signals when the feed axis is moved toward the end point, and the minus side indicates the number of pulse signals when the feed axis is moved toward the start point. FIG. 6B shows the number of pulse signals to be output to the spindle amplifier when the pulse signals shown in FIG. 6A are output.

When the feedrate of the feed axis is decelerated, the controller 23 gradually decreases the number of pulse signals to be output to the servo amplifier in each control cycle, as shown in FIG. 6A. Furthermore, when the condition for reversing the feed direction of the feed axis is satisfied, the controller 23 outputs pulse signals to the serve amplifier to move the feed axis toward the start point from the next control cycle. The controller 23 then gradually increases the number of pulse signals.

When the feedrate of the feed axis is decelerated, the controller 23 gradually decreases the number of pulse signals to be output to the spindle amplifier in each control cycle, as shown in FIG. 6B. Furthermore, when the condition for reversing the feed direction of the feed axis is satisfied, the controller 23 outputs pulse signals to the spindle amplifier cycle to rotate the rotary axis from the next control. Thus, the rotation of the rotary axis does not stop.

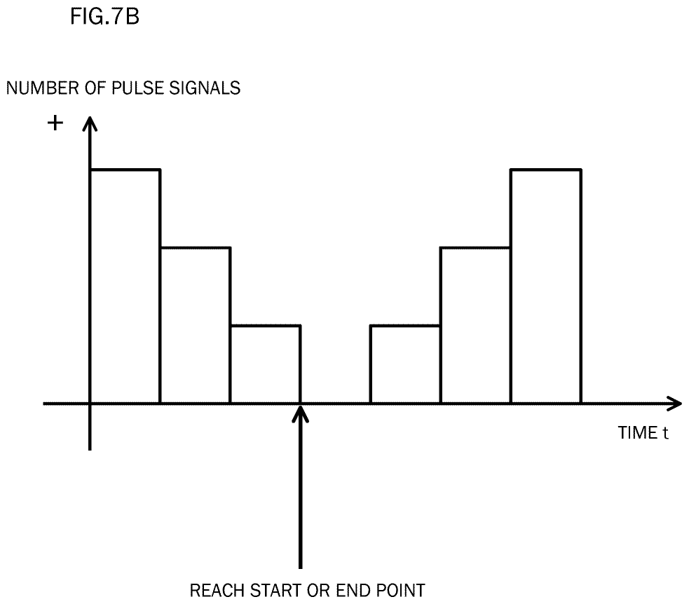

For a comparison purpose, an example of pulse signals to be output to a servo amplifier and an example of pulse signals to be output to a spindle amplifier according to a conventional art are shown in FIGS. 7A and 7B, respectively.

When a feedrate of a feed axis is decelerated, a controller gradually decreases the number of pulse signals to be output to the servo amplifier in each control cycle, as shown in FIG. 7A. Furthermore, when the feed axis reaches an end point, the controller stops outputting the pulse signals. The controller outputs the pulse signals to the serve amplifier from a control cycle subsequent to a control cycle during which the output of the pulse signals is stopped to move the feed axis toward a start point. The controller then gradually increases the number of pulse signals.

When the feedrate of the feed axis is decelerated, the controller gradually decreases the number of pulse signals to be output to the spindle amplifier in each control cycle, as shown in FIG. 7B. Furthermore, when the feed axis reaches the end point, the controller stops outputting the pulse signals to the spindle amplifier. The controller outputs the pulse signals to the spindle amplifier from a control cycle subsequent to a control cycle during which the output of the pulse signals is stopped so as to rotate the rotary axis. Thus, the rotary axis stops when it reaches the end point.

The operations of the tool in the honing will now be described.

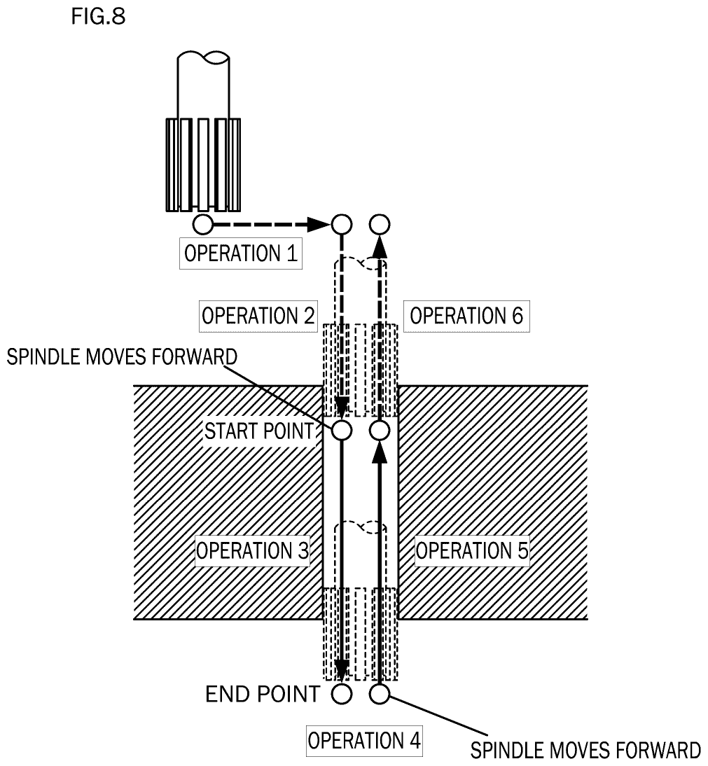

FIG. 8 shows an example of the operations of the tool in the honing. Firstly, the tool is positioned at its positioning point (Operation 1). At this time, the rotation of the spindle on which the tool is attached is stopped. Subsequently, the tool is moved to the start point (Operation 2).

Then, the rotation of the tool is started and the tool is moved toward the end point (Operation 3). While the tool is moving toward the end point, the synchronous control is performed to control the feedrate of the tool and the rotation speed of the tool. As the tool approaches the end point, the feedrate of the feed axis is decreased and the rotation speed of the tool is also decreased.

In a case where the condition for reversing the feed direction of the feed axis is satisfied before the tool reaches the end point, the feed direction of the tool is reversed (Operation 4). In this case, the rotation of the tool does not stop.

When the feed direction of the feed axis is reversed, the feedrate of the feed axis gradually increases and the rotation speed of the tool also gradually increases (Operation 5). While the tool is moving toward the start point, the synchronous control is conducted to control the feedrate of the tool and the rotation speed of the tool. Furthermore, when the tool approaches the start point, the feed axis decelerates and the rotation of the tool also decelerates.

In a case where the condition for reversing the feed direction of the feed axis is satisfied before the tool reaches the start point, the feed direction of the tool is reversed (Operation 6). At this time, the rotation of the tool does not stop.

After Operations 3 to 6 are repeated a predetermined number of times, the tool returns to the positioning point and the honing is completed.

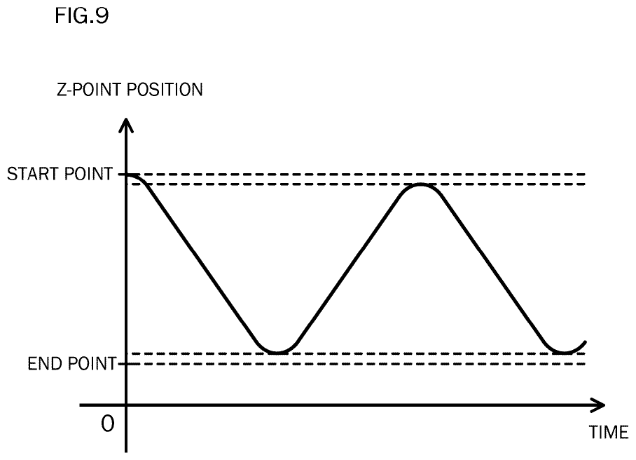

FIG. 9 shows a position change in a Z-axis direction of the tool during honing. The tool is moved from the start point toward the end point. When the feed axis approaches the end point and the condition for reversing the feed axis is satisfied, the feed axis is reversed. Thus, the feed direction is reversed before the feed axis reaches the end point. When the feed direction is reversed, the feed axis moves toward the start point. Furthermore, when the feed axis approaches the start point and the condition for reversing the feed axis is satisfied, the feed direction of the feed axis is reversed. Thus, the feed direction is reversed before the feed axis reaches the start point.

A description will now be made about processing conducted in the numerical control device 2.

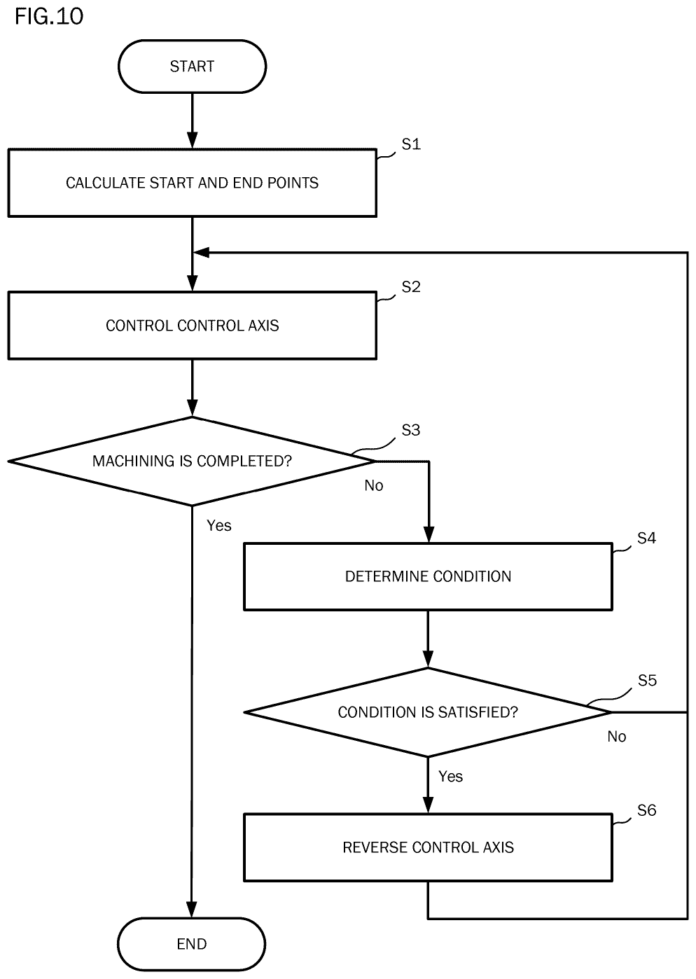

FIG. 10 is a flowchart showing an example of the processing conducted in the numerical control device 2. First, the calculator 22 calculates a start point and an end point of the reciprocation of the feed axis according to the machining program (Step S1).

Then, the controller 23 conducts the synchronous control between the start point and the end point calculated by the calculator 22 to control the feed movement of the feed axis and the feed relative rotational movement between the tool and the workpiece (Step S2).

When the machining is completed (Yes in Step S3), the processing is completed.

In a case where the machining is not yet completed, the determinator 24 determines whether or not the condition for reversing the feed direction of the feed axis is satisfied before the feed axis reaches the start point or the end point (Step S4).

When the determinator 24 determines that the condition is not satisfied (No in Step S5), the synchronous control is continued until the condition is satisfied.

When the determinator 24 determines that the condition is satisfied (Yes in Step S5), the controller 23 reverses the feed direction of the feed axis before the feed axis reaches the start or the end point (Step S6), and continues the control on the feed axis.

As described above, the numerical control device 2 includes the calculator 22 for calculating the start point and the end point of the reciprocation of the feed axis according to the machining program, the controller 23 for conducting the synchronous control between the start point and the end point calculated by the calculator 22 to control the feed movement of the feed axis and the relative rotational movement between the tool and the workpiece, and the determinator 24 for determining whether or not the condition for reversing the feed direction of the feed axis is satisfied during the synchronous control before the feed axis reaches the start point or the end point. When the determinator 24 determines that the condition is satisfied, the controller 23 reverses the feed direction of the feed axis before the feed axis reaches the start point or the end point. Furthermore, the condition for reversing the feed direction of the feed axis can be that the rotation speed in the rotational movement reaches a predefined rotation speed or lower.

Thus, the numerical control device 2 can reverse the feed direction of the feed axis without stopping the rotation of the rotary axis. This can prevent deterioration in the quality of the machined face of the workpiece.

According to the above-described embodiment, the controller 23 reverses the feed direction of the feed axis under the condition that the rotation speed of the rotary axis reaches the predefined rotation speed or lower. However, the condition for reversing the feed direction of the feed axis is not limited thereto. For example, the controller 23 may reverse the feed direction of the feed axis under a condition that the feedrate of the feed axis reaches a predefined feedrate or lower.

Furthermore, the controller 23 may reverse the feed direction of the feed axis under a condition that a position error between the position of the feed axis and the rotation angle of the rotary axis that occurs when reversing the feed direction of the feed axis is estimated to be less than a predefined reference position error. The controller 23 may also reverse the feed direction of the feed axis under a condition that a speed error between the feedrate of the feed axis and the rotation speed of the rotary axis that occurs when reversing the feed direction of the feed axis is estimated to be less than a predefined reference speed error.

A relational expression representing the relation between the position of the feed axis and the position error and a relational expression representing the relation between the feedrate and the speed error may be determined in advance based on experiments, for instance. Furthermore, the numerical control device 2 may include an estimation unit for estimating the position error or the speed error in real time on the basis of these relational expressions.

In addition to that, the controller may reverse the feed direction of the feed axis under a condition that an angle error between the crosshatch angles that occurs when reversing the feed direction of the feed axis is estimated to be less than a predefined reference angle error.

The angle error is calculated, for example, based on the relational expression representing the relation between the feedrate of the feed axis and the speed error as well as the following Equation 1 or 2 for determining the crosshatch angle. Equation 1 is for determining the crosshatch angle in a feed per minute mode. Equation 2 is for determining the crosshatch angle in a feed per revolution mode.

$$α = 2 tan ( v / ω D ) \qquad [ Equation 1 ]$$

$$α = 2 tan ( v / D ) \qquad [ Equation 2 ]$$

In here, a indicates the crosshatch angle, v indicates the feedrate of the tool, w indicates the rotation speed of the rotary axis, and D indicates the machining diameter. The numerical control device 2 may include an estimation unit for estimating the angle error in real time during the synchronous control.

In the above-described embodiment, the condition for reversing the feed direction of the feed axis may be designated by the machining program. For example, the condition may be designated by using code “P_” in the honing cycle command. To code “P_”, at least one of the following is assigned: the rotation speed of the rotary axis; the feedrate of the feed axis; the reference position error; the reference speed error; and the reference angle error, by way of example.

The present disclosure is not limited to the above-described embodiments, and can be varied appropriately without departing from the gist of the invention. In the present disclosure, it is possible to modify any constitutional elements of the embodiments or omit any constitutional elements of the embodiments.

### REFERENCE NUMERALS LIST

1 Machine Tool
2 Numerical Control Device
21 Storage
22 Calculator
23 Controller
24 Determinator
201 Hardware Processor
202 Bus
203 ROM
204 RAM
205 Non-Volatile Memory
206 Interface
207 Axis Control Circuit
208 Spindle Control Circuit
209 PLC
210 I/O Unit
3 Input/Output Device
4 Servo Amplifier
Servo Motor
6 Spindle Amplifier
7 Spindle Motor
8 Auxiliary Device

1. A numerical control device, comprising:
a calculator for calculating a start point and an end point of reciprocation of a feed axis by using a machining program;
a controller for conducting synchronous control between the start point and the end point calculated by the calculator to control feed movement of the feed axis and relative rotational movement between a tool and a workpiece; and
a determinator for determining whether or not a condition for reversing a feed direction of the feed axis is satisfied during the synchronous control before the feed axis reaches the start point or the end point, wherein
when the determinator determines that the condition is satisfied, the controller reverses the feed direction of the feed axis before the feed axis reaches the start point or the end point.

2. The numerical control device according to claim 1, wherein the condition is that a rotation speed in the rotational movement reaches a predefined rotation speed or lower, or a feedrate of the feed movement reaches a predefined feedrate or lower.

3. The numerical control device according to claim 1, wherein the condition is that a position error between a position of the feed axis and a rotation angle of the rotary axis that occurs when reversing the feed direction of the feed axis is estimated to be less than a predefined reference position error, or that a speed error between the feedrate of the feed axis and the rotation speed of the rotary axis that occurs when reversing the feed direction of the feed axis is estimated to be less than a predefined reference speed error.

4. The numerical control device according to claim 1, wherein the condition is that an angle error between crosshatch angles that occurs when reversing the feed direction of the feed axis is estimated to be less than a predefined reference angle error.

5. A computer-readable storage medium for storing commands to allow a computer to conduct:
calculation of a start point and an end point of reciprocation of a feed axis by using a machining program;
synchronous control between the start point and the end point thus calculated on feed movement of the feed axis and relative rotational movement between a tool and a workpiece;
determination as to whether or not a condition for reversing a feed direction of the feed axis is satisfied during the synchronous control before the feed axis reaches the start point or the end point; and
when it is determined that the condition is satisfied, reverse of the feed direction of the feed axis before the feed axis reaches the start point or the end point.
